(19) United States
(12) Patent Application Publication
(10) Pub. No.: US 2018/0124323 A1
(43) Pub. Date: May 3, 2018

(54) SYSTEM AND METHOD FOR CARRYING OUT ADJUSTMENT OPERATIONS ON A MOTOR VEHICLE

(71) Applicant: Robert Bosch GmbH, Stuttgart (DE)

(72) Inventors: Christian Wagmann, Muenchen (DE); Jan Witkamp, Muenchen (DE); Johann Legen, Muensing (DE); Juergen Lumera, Hohenkammer (DE); Marco Oliver Kempin, Herbertshausen/Unterweilbach (DE)

(21) Appl. No.: 15/572,832

(22) PCT Filed: Mar. 21, 2016
(86) PCT No.: PCT/EP2016/056081

§ 371 Date: Nov. 9, 2017

(30) Foreign Application Priority Data
May 20, 2015 (DE) 10 2015 209 246.1

(51) Int. Cl. H04N 5/232; G01B 11/275; H04N 5/76; G06K 9/62

(52) U.S. Cl. CPC H04N 5/23293; G01B 11/2755; G01B 2210/143; G06K 9/6202; G01B 2210/26; H04N 5/76

(57) ABSTRACT

A system and a method for performing adjustment operations on a motor vehicle, in particular during an axle measurement, having at least one camera for recording images of one or more vehicle detail(s), a data-processing unit for processing the images recorded by the camera, a memory, which includes documentation and/or image information about adjustment operations on motor vehicles, a playback device for displaying documentation and/or images and/or image information, and an axle-measuring device, which supplies data pertaining to the measuring of the motor vehicle to the data-processing unit.

### FIELD

The present invention relates to a system and to a method for carrying out adjustment operations on a motor vehicle.

### BACKGROUND INFORMATION

A motor vehicle is regularly checked in the service facility for correct track or camber values. These values can be ascertained with the aid of an axle-measuring device. At present, a service technician performs adjustment operations on the vehicle as a function of the values that were ascertained with the aid of the axle-measuring device. Since the service technician is located underneath the vehicle at the time when this work is carried out, an exchange between the axle-measuring device and the service technician during the adjustment operation may perhaps be possible only to a limited extent.

### SUMMARY

It is an object of the present invention to provide a system and a method for carrying out adjustment operations on a motor vehicle. In conventional systems and methods, there is no interaction between the axle-measuring device and the repair manuals that a user may possibly consult in order to make adjustments, for instance to the track.

A user is able to determine the track and/or camber of a vehicle with the aid of an axle-measuring device and then consult repair manuals that are available in printed or electronic form. After the adjustment work has been performed, the user must carry out another axle measurement in order to ensure that the work was done correctly.

The present invention may allow for comfortable work of the mechanic since a direct exchange of data between the axle-measuring device and a playback device takes place. In this context, the playback device assumes the function of a repair manual with additional functions inasmuch as the user is selectively informed of the subsequent working step as a function of the current working operation. The information may be so detailed that the user is informed about the direction of rotation of a screw.

Errors in the execution of the adjustment operations are avoided since the user is able to be directly notified if a screw is rotated in the wrong direction or if the track value is adjusted in the wrong direction. Because the axle-measuring device communicates directly with the data-processing unit, an incorrect execution of a working operation can be communicated directly to the user. In this way, it is avoided that the user has to carry out the entire adjustment operation all over again when he notices the error only after the work has been completed.

A playback device in the form of data glasses is advantageous because in this case the user does not have to constantly change the direction of his gaze between the playback device and the motor vehicle. The user is less distracted and better able to concentrate on the current working operation and the next working step.

An input device for the interaction between a user and the system is advantageous because the input device is able to provide the system with information that would possibly not be ascertainable on the basis of the images from the camera alone. Perhaps the system is unable to identify a certain vehicle type, so that a direct input of the vehicle type by the user would be useful. In the process, the input device is advantageously controllable by manual, visual and/or auditory interactions.

The present method offers a special advantage when a comparison of the images with image information of motor vehicles is carried out, the comparison being used to identify the motor vehicle on which the adjustment work is performed. When the system identifies the motor vehicle, incorrect inputs of the user are able to be avoided. If a manual and incorrect vehicle identification by the user occurs at the start of the adjustment operations, then the system calculates an incorrect setpoint value for the track, and all of the adjustment operations are carried out incorrectly. If the identification of the motor vehicle is done automatically by the system, then an error of the user is able to be corrected and the user is informed of the correct working steps. It is advantageous in this context if the identification of the motor vehicle is taken into account in the display of documentation and/or images and/or image information pertaining to adjustment operations and subsequent working steps.

Periodic and/or continuous and/or repeated measuring of the motor vehicle by the axle-measuring device while the adjustment work is performed is advantageous, the respective axle-measuring data being transmitted to the data-processing device. Here, the system is able to rapidly determine an error in the execution of the adjustment operations if the axle-measuring data does not change in the desired direction.

To inform the user at all times about the current status of the adjustment work on the vehicle, it is advantageous to display the documentation and/or of images and/or image information pertaining to adjustment operations and to subsequent working steps on the display device, which are updated as a function of the respective axle-measurement data and/or the respective images across one or more working operations.

Preferred exemplary embodiments of the present invention are shown in the figures and described in greater detail below.

### BRIEF DESCRIPTION OF THE DRAWINGS

FIG. 1 shows an exemplary embodiment of a system for performing adjustment operations on a motor vehicle.

FIG. 2 shows a flow diagram with the steps of a method for performing adjustment operations on a motor vehicle.

### DETAILED DESCRIPTION OF EXAMPLE EMBODIMENTS

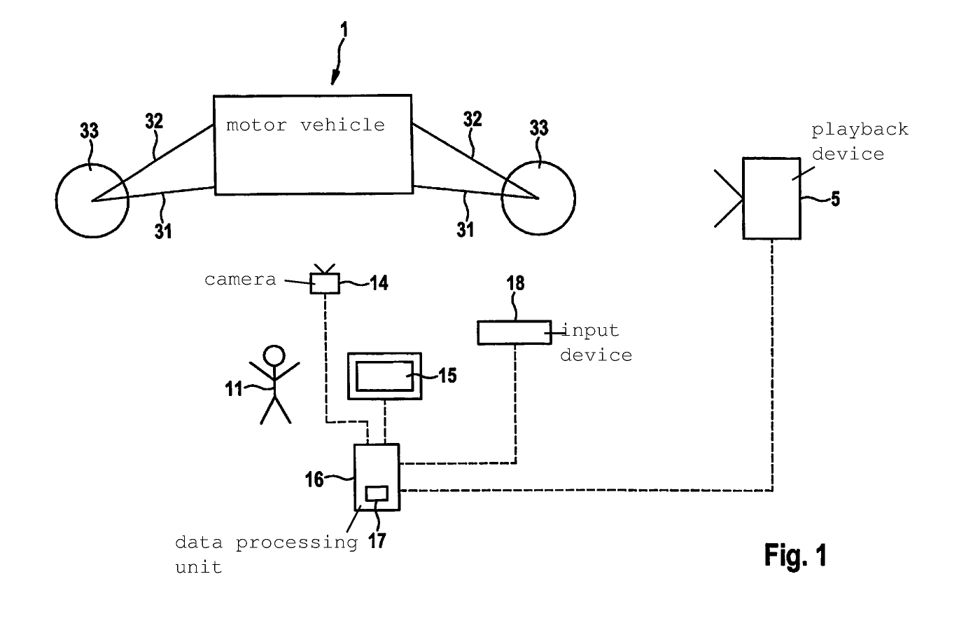

FIG. 1 shows a schematic representation of a motor vehicle 1, of which only the two front wheels 33 are shown. Front wheels 33 are connected to motor vehicle 1 by a wheel mount 31 and a tie rod 32.

A user 11, which is a service-facility member 11 in this particular exemplary embodiment, carries out one or more working steps in order to perform adjustment operations on motor vehicle 1. User 11 uses a system for performing adjustment operations that assists him while he is carrying out the working steps on motor vehicle 1.

The system includes a camera 14. Camera 14 may be integrated into glasses of a user 11 so that camera 14 is pointing to the same vehicle details of vehicle 1 as the gaze direction of user 11 while the adjustment operations are carried out. For example, vehicle details may be wheel mount 31 and/or tie rod 32 and/or front wheels 33 of the motor vehicle. However, vehicle details may also relate to smaller areas of tie rod 32, e.g., the adjustment nut that needs to be rotated by the user or technician in order to modify the track.

Camera 14 may also be integrated into a portable computer. The portable computer could be a laptop, a tablet or a smartphone, which is equipped with a camera 14. In this case, user 11 must point camera 14 at the vehicle detail of motor vehicle 1 on which the adjustment operation is to be carried out.

During the adjustment operations, camera 14 records images of one or more vehicle detail(s) and transmits the recorded images to a data-processing unit 16, which is part of the system.

In addition, the system has a memory 17, which includes documentation and/or image documentation pertaining to the recommended working steps during the performance of the adjustment operations. This documentation may be texts that are displayed on a playback device 15 and show user 11 how to proceed during the adjustment operations. The documentation may also include spoken instructions that point out to user 11 via a loudspeaker or an audio set how to proceed during the adjustment operations.

The memory also includes image information of vehicle details of different types of motor vehicles 1.

The image information may include images of respective motor vehicle 1 in which the components of motor vehicle 1 on which the subsequent working steps will have to be performed are highlighted, e.g., by arrows or circles.

Playback device 15 may be integrated into a computer as a screen. In one alternative exemplary embodiment, playback device 15 is data glasses that user 11 is wearing while performing the adjustment operations.

The system also includes an axle-measuring device 5, which supplies axle-measurement data pertaining to the measurements of motor vehicle 1 to data-processing unit 16.

Axle-measuring device 5 carries out measurements on wheels 33 of motor vehicle 1 and transmits axle-measurement data, e.g., track and/or camber values, to data-processing unit 16.

The system may have an input device 18, which is provided for the interaction between a user 11 and the system. With the aid of input device 18, the user is able to supply information to data-processing unit 16. For example, this may be information about the vehicle type in order to identify motor vehicle 1 on which the adjustment operations are performed.

Camera 14, data-processing unit 16, memory 17, playback device 15, and input device 18 may be combined as desired and be integrated into any technically known information-processing device. It is important that user 11 is able to point camera 14 at the vehicle details of the motor vehicle on which the adjustment operations are performed. In addition, user 11 should have a good view of playback device 15 during the adjustment operations so that it is able to render assistance to user 11 by displaying documentation and/or images and/or image information during the course of the adjustment operations.

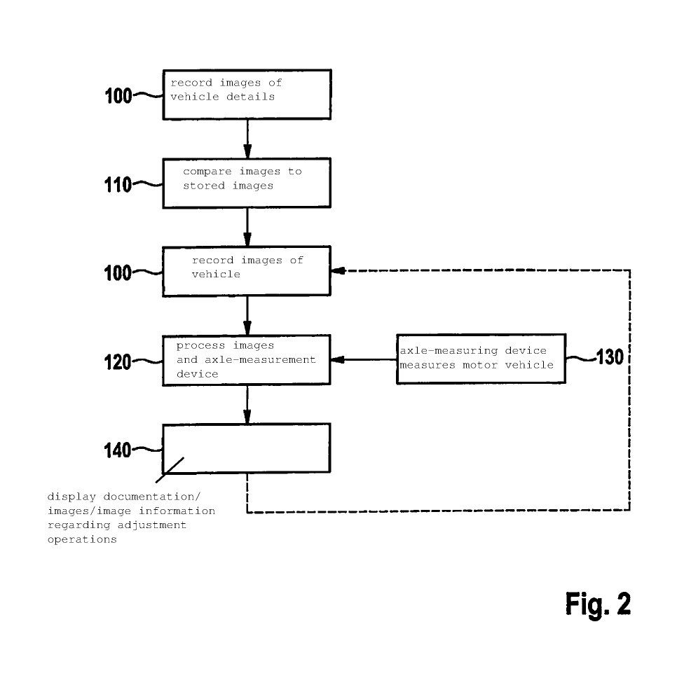

FIG. 2 shows the method steps that are carried out by the system and are meant to assist a user 11 during the performance of adjustment operations on a motor vehicle 1. The method steps are explained with the aid of a vehicle 1 on which the track is to be newly adjusted.

In step 100, camera 14 records images of vehicle details. Since user 11 is intent on readjusting the track, the images pertain to images of wheel 33 with wheel mount 31 and tie rod 32 or to detail images of the aforementioned objects.

In step 110, the images are compared to image information pertaining to vehicle details of motor vehicle 1 that are stored in memory 17 in order to identify motor vehicle 1. For example, the identification may be performed on the basis of the shape and/or the alignment of wheel mount 31 and/or tie rod 32. In the process, the images are allocated to stored image information of a motor vehicle type with the aid of image-processing algorithms. Depending on the type of adjustment operations, an allocation to a particular chassis platform or vehicle brand will be sufficient.

The identification of the motor vehicle in step 110 may also be performed by user 11. To do so, user 11 is able to input the required information for the identification of motor vehicle 1 via input device 18.

In step 120, the images, recorded by the camera, and the axle-measurement data that were recorded in a step 130 by axle-measuring device 5, are processed by data-processing unit 16. Data-processing unit 16 recognizes the current stage of the adjustment operations on motor vehicle 1 by comparing the images that are recorded by the camera and pertain to one or more vehicle detail(s) with image information stored in memory 17.

In step 130, axle-measuring device 5 measures motor vehicle 1 in order to obtain relevant axle-measurement data for the adjustment operations. In the current example, this involves the track values of motor vehicle 1, which are transmitted to data-processing unit 16 after the axle measurement. However, it is also possible to measure other variables and to transmit the respective data to data-processing unit 16.

In step 140, documentation and/or images and/or image information pertaining to the adjustment operations and/or subsequent working steps is/are displayed by a playback device 15. They inform user 11 of the next working step, the location at which the working step is to be performed, and the current progress of his work. For example, the current track value may be displayed as the actual value, and the track value required for the motor vehicle may be displayed as the setpoint value. By arrows or circles, user 11 is able to be informed of the location at which the next working step is to be carried out, and texts that inform user 11 about the next working step may be superimposed.

Working steps 100, 120, 130 and 140 may be repeated any number of times until playback device 15 informs user 11 that the setpoint value as track value has been reached or that there is no longer a deviation between the track value as the actual value and the track value as the setpoint value.

During the adjustment operations, periodic and/or continuous and/or repeated measuring of motor vehicle 1 is able to take place with the aid of the axle-measuring device, and the respective axle-measuring data can be transmitted to data-processing unit 16.

The display of the documentation and/or images and/or image information pertaining to adjustment operations and subsequent working steps on playback device 15 takes place as a function of the respective axle-measuring data and/or the respective images of one or more vehicle detail(s). As a result, the user is always kept up-to-date about the next working step as a function of the progress of the user's current adjustment operations.

1-10. (canceled)

11. A system for performing adjustment operations on a motor vehicle during an axle measurement, the system comprising:
at least one camera for recording images of at least one vehicle detail;
a data-processing unit for processing the images recorded by the camera;,
a memory storing at least one of documentation and image information, about at least one of: (i) adjustment operations on motor vehicles, and (ii) image information of vehicle details;
a playback device to displaying at least one of documentation, images and image information; and
an axle-measuring device which measures the motor vehicle and supplies axle-measurement data to the data-processing unit.

12. The system as recited in claim 11, wherein the playback device is data glasses.

13. The system as recited in claim 11, further comprising:
an input device for the interaction between a user and the system.

14. The system as recited in claim 13, wherein the input device is controllable by at least one of manual, visual, and auditory interaction.

15. A method for performing adjustment operations on a motor vehicle during an axle measurement, the method comprising:
recording images of at least one vehicle detail using at least one camera;
comparing the images with image information regarding vehicle details of motor vehicles in a data-processing unit, the image information being stored in a memory;
measuring the motor vehicle with the aid of an axle-measuring device, and transmitting the axle-measurement data to the data-processing unit; and
displaying at least one of documentation, images, and image information, the at least one of document, images and image information pertaining to adjustment operations and subsequent working steps on a playback device.

16. The method as recited in claim 15, wherein a comparison of the images with image information of vehicle details of different motor vehicles takes place, the comparison being performed in order to identify the motor vehicle on which the adjustment operations are performed.

17. The method as recited in claim 16, wherein the display of the at least one of the documentation, images, and image information about adjustment operations and subsequent working steps takes place taking the identification of the motor vehicle into account.

18. The method as recited in claim 15, wherein the axle-measurement data involve at least one of track values and camber values of the motor vehicle.

19. The method as recited in claim 15, wherein at least one of periodic, continuous and repeated measuring of the motor vehicle by the axle-measuring device takes place during the performance of the adjustment operations, and the respective axle-measurement data are transmitted to the data-processing unit.

20. The method as recited in claim 19, wherein the display of the at least one of the documentation, images, and image information pertaining to adjustment operations and subsequent working steps on the playback device is updated as a function of at least one of the respective axle-measurement data and the respective images of the at least one of the vehicle details.
